(19) United States
(12) Patent Application Publication
(10) Pub. No.: US 2026/0054739 A1
(43) Pub. Date: Feb. 26, 2026

(54) METHOD FOR OPERATING A MOTOR VEHICLE, CONTROL DEVICE AND MOTOR VEHICLE

(71) Applicant: Robert Bosch GmbH, Stuttgart (DE)

(72) Inventors: Christoph Diekmann, Besigheim (DE); David Volkmer, Marbach Am Neckar (DE); Heiko Walter, Untergruppenbach (DE); Marcel Bastian, Tamm (DE); Maximilian Bayer, Tamm (DE); Michael Hofmann, Mannheim (DE); Philipp Seibold, Fellbach (DE); Sebastian Stolz, Neckarwestheim (DE); Thorsten Maucher, Heidelberg (DE)

(21) Appl. No.: 19/105,647

(22) PCT Filed: Nov. 20, 2023
(86) PCT No.: PCT/EP2023/082403

§ 371 Date: Feb. 21, 2025

(30) Foreign Application Priority Data
Nov. 29, 2022 (DE) 10 2022 212 808.7

(51) Int. Cl. B60W 50/029; B60W 50/023; B60W 60/00

(52) U.S. Cl. CPC B60W 50/029; B60W 50/023; B60W 60/001; B60W 2540/10; B60W 2540/12; B60W 2540/18

(57) ABSTRACT

A method for operating a motor vehicle. The motor vehicle includes at least one actuating device which can be actuated by a driver for specifying a braking, acceleration and/or steering request. The actuating device is assigned at least one first sensor for detecting an actuation of the actuating device. The actuating device and/or the first sensor (5) are monitored for a malfunction. If a malfunction of the actuating device and/or the first sensor has been detected, an at least partially autonomous driving mode of the motor vehicle is activated and at least one autonomous driving maneuver is carried out as a function of the value of at least one specified parameter assigned or assignable to the motor vehicle.

### FIELD

The present invention relates to a method for operating a motor vehicle, wherein the motor vehicle comprises at least one actuating device which can be actuated by a driver for specifying a braking, acceleration and/or steering request, wherein the actuating device is assigned at least one first sensor for detecting an actuation of the actuating device, and wherein the actuating device and/or the first sensor are monitored for a malfunction.

The present invention also relates to a control device for a motor vehicle and a motor vehicle.

### BACKGROUND INFORMATION

Detecting an actuation of an actuating device for a motor vehicle which can be actuated by a driver by means of a sensor assigned to the actuating device is described in the related art. If the driver actuates the actuating device, in particular a braking or acceleration request of the driver is detected as a function of this. Available in the related art, for instance, are brake systems with electromechanical brake boosters that, together with a vehicle assistance system, in particular an electronic stability program (ESP), form a redundant brake-by-wire system in which there is no mechanical connection from the actuating device to the brake system. A braking request is forwarded, for example as a function of an actuation of the actuating device, to an electromechanical actuator which is configured to build up pressure in the brake system.

Certain methods for detecting malfunctions of the actuating device and/or the sensor are conventional as well. German Patent Application No. DE 10 2018 113 865 A1, for example, describes method for determining the state of a pedal actuation system in a vehicle, wherein a normal operating state or an error state of an actuating pedal is detected as a function of two sensor signals.

### SUMMARY

A method according to an example embodiment of the present invention includes that, if a malfunction of the actuating device and/or the first sensor has been detected, an at least partially autonomous driving mode of the motor vehicle is activated and at least one autonomous driving maneuver is carried out as a function of the value of at least one specified parameter assigned or assignable to the motor vehicle. This advantageously ensures safe continued operation of the motor vehicle if it is no longer possible to clearly determine and implement an actuation of the actuating device due to a faulty actuating device and/or a faulty sensor. An autonomous driving mode is in particular activated automatically, i.e. without the driver being able to intervene. The driving mode is preferably activated permanently and transfer of control to the driver is prevented. There is therefore no need to set an emergency trajectory, for example controlled stopping of the motor vehicle, in which the motor vehicle is brought to a standstill as a safe state as quickly as possible and held; the motor vehicle instead continues to be operated in the normal, at least partially autonomous driving mode, at least for the time being.

There is in particular no provision to transfer of control of the motor vehicle to the driver, at least as long as the malfunction is not identified as having been resolved. In the event of such a malfunction, the motor vehicle can advantageously only be operated safely in autonomous driving mode. When a malfunction is detected, a corresponding message is particularly preferably output to the driver, for example on a display device assigned to the driver. The message in particular includes information about the activation of the at least partially autonomous driving mode and/or an instruction to the driver to check and address the malfunction, for example a request to take the vehicle to a workshop.

According to a preferred further development of the present invention, it is provided that the actuating device is assigned at least one second sensor for redundantly detecting the actuation, and that sensor signals from the sensors are monitored for a malfunction, in particular by comparing them with one another. The redundant detection of the actuation of the actuating device has the advantage that reliable detection of a respective input of the driver is ensured at all times, even if one of the sensors fails. The actuation of the actuating device is preferably detected by means of one or two sensors disposed on the actuating device, for example angle sensors, displacement sensors, pressure sensors or force sensors, and the at least partially autonomous driving mode is in particular activated only when these sensors fail. Control therefore advantageously has to only be taken away from the driver if all of the sensors have failed or are defective.

According to an example embodiment of the present invention, it is particularly preferably provided that a steering device, a brake system and/or a drive unit of the motor vehicle are controlled as a function of an actuation of the actuating device. Such a configuration of the actuating device advantageously ensures that a steering request, acceleration request and/or deceleration request of a driver of the motor vehicle is reliably detected. The actuating device is preferably part of a steer-by-wire system, a brake-by-wire system and/or a drive-by-wire system; i.e. it has no mechanical connection to the steering device, brake system and/or drive unit. The actuation is in particular detected as a function of a displacement path and/or a spatial position of the actuating device. The actuating device is in particular configured as an actuating surface, pedal, joystick or steering handle. The actuating surface is preferably configured to output acceleration and/or deceleration requests to the brake system and/or the drive unit. In particular an actuating force of the actuating surface is ascertained for this purpose. The actuating surface is preferably at least largely stationary or without travel, i.e. not or at least only slightly displaceable. The pedal is preferably an accelerator pedal, a brake pedal or a combined accelerator pedal that is configured to output acceleration and deceleration requests to both the brake system and/or the drive unit. With such an output and control, the advantages of the method according to the present invention are particularly pronounced. The joystick is particularly preferably configured to output both acceleration requests and deceleration requests, and in particular alternatively or additionally steering requests. In particular a displacement path, an angle of movement and/or a speed of actuation of the joystick or pedal are acquired for this purpose. An acceleration request or a deceleration request is preferably detected in particular as a function of a direction of movement of the joystick, and either the drive unit or the brake system is controlled accordingly. A vehicle deceleration request is set by a driver via the joystick, for instance. A signal is transmitted to a component of a brake system of the motor vehicle, for example a controllable actuator, according to its movement, in particular its movement speed or its angle of movement, and a corresponding brake pressure is built up by the actuator as described above.

According to a preferred further development of the present invention, it is provided that a driving mode according to SAE level 3 (automated), level 4 (highly automated) or level 5 (fully automated) is activated, and that the driving mode can only be deactivated again or is deactivated when the malfunction is identified as having been resolved, and/or that control over the faulty and/or another actuating device is taken away from the driver. Deactivating or allowing deactivation only if the malfunction has been resolved advantageously ensures safe continued operation of the motor vehicle. Taking control of the actuating device away advantageously ensures that the driver cannot intervene in the control of the motor vehicle in a way that interferes with the autonomous driving mode and thus potentially jeopardizes the safe continued operation of the motor vehicle. As an alternative to taking away control, at least sensor signals representing the actuation of the respective actuating device are ignored as driver requests. Depending on the type of malfunction, control of not only the faulty actuating device is taken away from the driver but preferably also control of another actuating device. If, for example, a malfunction of the brake pedal or the sensor assigned to the brake pedal is detected, in particular not only control of the brake pedal is taken away from the driver but also control of an accelerator pedal, or at least signals representing its actuation are no longer taken into account as driver requests. The driver is then only able to steer or specify a steering request via a steering handle, while the partially autonomous driving mode involves independent acceleration and deceleration of the motor vehicle. This advantageously prevents the driver from specifying a speed that is too high, for example, even though any braking request from the driver cannot even be detected due to the malfunction.

It is particularly preferably provided according to an example embodiment of the present invention that the parameter includes a severity and/or a type of malfunction. This has the advantage that the driving mode and the driving maneuver are always adapted to the driving situation that results from the malfunction. If, for example, there is a multiple error, in particular in two actuating devices and/or in the sensors assigned to them, a higher level of automation is selected than for a single error, for instance. If, for example, neither braking requests nor acceleration requests by means of the brake pedal and the accelerator pedal are detectable, a fully autonomous driving mode is in particular selected in which the driver can no longer intervene in the control of the motor vehicle, and can in particular also not specify any steering requests. In the case of only single errors, for example, such as a malfunction of the accelerator pedal, the driver is preferably given a choice of different driving maneuvers and different degrees of interaction, i.e. the extent to which the driver can still intervene in the control of the motor vehicle, depending on the severity and/or type of malfunction. In the event of multiple errors, a fully autonomous driving mode is automatically specified for safety reasons, in particular as described above, without the driver being able to make a selection or intervene.

According to a preferred further development of the present invention, it is provided that an error state of at least one further component of the motor vehicle is monitored and that the parameter includes said error state. Taking into account the error state of the further component creates a particularly advantageous ability to select one or more suitable autonomous driving maneuvers. If, for example, it is determined that there is not only a malfunction of the brake pedal but also in the brake system as a whole, an autonomous driving maneuver is in particular carried out in such a way that the motor vehicle is brought to a safe standstill in an appropriate location as quickly as possible. If, on the other hand, there is only a malfunction of the accelerator pedal, for example, and no other component of the motor vehicle is in an error state, the at least partially autonomous driving mode in which the driver can in particular specify steering requests and braking requests him or herself is permanently activated. In the case of only single errors, such as a malfunction of the accelerator pedal without any malfunctions of other components of the motor vehicle, for example, the driver is in particular given a choice of different driving maneuvers and/or different degrees of interaction, i.e. the extent to which the driver can still intervene in the control of the motor vehicle, depending on the error state of the at least one further component. In the event of multiple errors, a fully autonomous driving mode is automatically specified for safety reasons, in particular as described above, without the driver being able to make a selection or intervene.

According to an example embodiment of the present invention, it is particularly preferably provided that location information of the motor vehicle is acquired and that the parameter includes said location information. Taking into account the location information has the advantage that the current position of the motor vehicle is taken into account when determining the driving maneuver(s). The location information is in particular used to determine which driving maneuvers are appropriate. Preferably, driving maneuvers for bringing the motor vehicle to a safe standstill are specified. If the location information is now taken into account, suitable locations are preferably excluded. For example, it is specified that the motor vehicle should not to come to a standstill in a tunnel, a construction site or on the shoulder of a roadway, and the driving maneuvers are accordingly set to prevent this. Appropriate locations are preferably ascertained depending on the location information. For example, it is specified that the motor vehicle should come to a standstill in a parking lot, in particular the nearest one.

According to a preferred further development of the present invention, it is provided that environment information and/or surroundings information of the motor vehicle is acquired and that the parameter includes said environment information and/or surroundings information. Taking into account the environment information and/or the surroundings information advantageously ensures that particularly suitable driving maneuvers are selected. Sensor data from a vehicle assistance system of the motor vehicle are evaluated, for instance; in particular the positions of other road users around the motor vehicle are evaluated to ensure that they are not put at risk by the initiation of the autonomous driving mode. Particularly preferably, the condition of a road on which the motor vehicle is traveling and/or weather conditions in the vicinity of the motor vehicle are evaluated. If a malfunction of a brake pedal is detected, for instance, more defensive driving maneuvers, in particular at lower speeds, are specified in unfavorable road surface conditions and/or weather conditions, in particular snow and ice, than in favorable road surface conditions or weather conditions, for example on a dry road.

According to an example embodiment of the present invention, it is particularly preferably provided that the parameter includes a setting of a vehicle assistance system of the motor vehicle. Taking into account the setting of the vehicle assistance system has the advantage that a driver request is reliably taken into account. The setting defines a specific preference of the driver with respect to the at least partially autonomous driving mode, for example, in particular in terms of the level of automation (level 3 to 5). This preference is then taken into account when specifying the driving maneuver.

According to a preferred further development of the present invention, it is provided that at least one destination, in particular a plurality of destinations for the motor vehicle is/are specified or retrieved, and that the parameter includes said destination or at least one of the destinations. This creates a particularly advantageous ability to determine the appropriate driving maneuver(s). The driving maneuver(s) is/are then selected such that the specified or retrieved destination is reached safely. For instance, at least one of the destinations is a home address of the driver, a workshop, in particular the nearest workshop based on the location information of the motor vehicle, and/or a destination address retrieved or specified by the driver.

According to an example embodiment of the present invention, it is particularly preferably provided that a suitable destination is selected from a plurality of destinations as a function of the severity and/or type of malfunction, the error state, the location information, the environment information, the surroundings information and/or the setting of the vehicle assistance system, and that a plurality of autonomous driving maneuvers are carried out to reach the selected destination. Such a selection of a suitable destination creates a particularly advantageous option for continuing to operate the motor vehicle. Taking into account the location information preferably targets the destination selected from a home address of the driver, a workshop, and a destination address that has the shortest distance to the current location of the motor vehicle. Setting and driving to a destination depends in particular on a severity and/or type of malfunction as described above. In autonomous driving mode, for instance, the vehicle is automatically driven to a nearest workshop by means of suitable driving maneuvers. The driver is further preferably given a choice of at least two, in particular a plurality of potentially suitable destinations depending on at least one of the stated parameters. Alternatively, as described above, for safety reasons, exactly one suitable destination is specified and targeted without the driver being able to make a selection or intervene.

A control device according to the present invention for a motor vehicle is specially designed to carry out the method according to the present invention. This results in the aforementioned advantages.

A motor vehicle according to the present invention comprises at least one actuating device which can be actuated by a driver and at least one first sensor and includes the control device according to the present invention. This, too, results in the aforementioned advantages.

Further preferred features and combinations of features result from the above-described and the rest of the disclosure herein. The present invention will be explained in more detail in the following with reference to the figures.

### BRIEF DESCRIPTION OF THE DRAWINGS

FIG. 1 shows a motor vehicle according to an example embodiment of the present invention.

FIG. 2 shows a method for operating the motor vehicle according to an example embodiment of the present invention.

### DETAILED DESCRIPTION OF EXAMPLE EMBODIMENTS

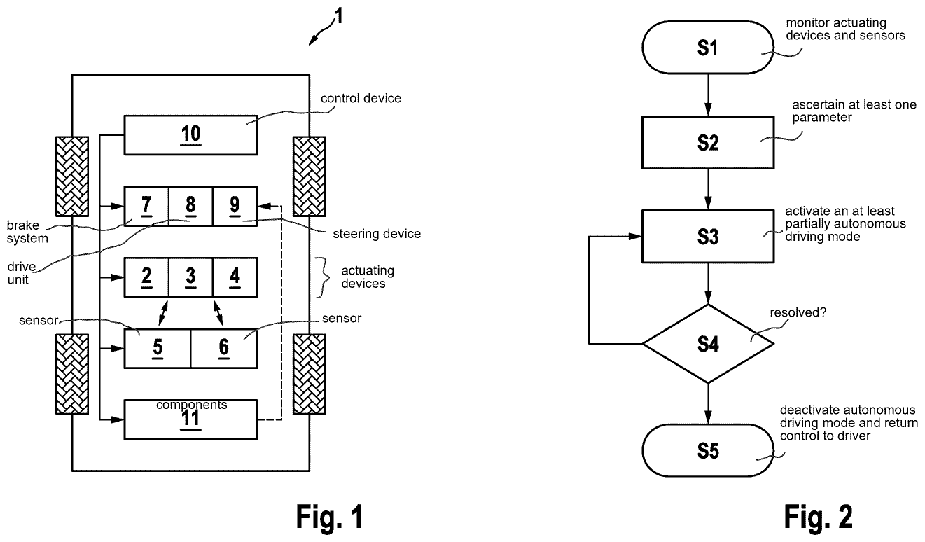

FIG. 1 shows a motor vehicle 1; in this case comprising a first actuating device 2, for example configured as a brake pedal, a second actuating device 3, for example configured as an accelerator pedal, and a third actuating device 4, for example configured as a steering handle. The actuating devices 2, 3, 4 are all configured to be actuated by a driver of the motor vehicle 1.

For this purpose, each of the actuating devices 2, 3, 4 here is assigned a first sensor 5 and a second sensor 6 for redundantly detecting actuation of the actuating device 2, 3, 4 as indicated by respective double arrows. For the sake of clarity, only one of the sensors 5, 6 is shown in each case in FIG. 1. A brake system 7, a drive unit 8 and a steering device 9 of the motor vehicle 1 are controlled as a function of a detected actuation of the actuating device 2, 3, 4.

The motor vehicle 1 further comprises at least one control device, in particular a plurality of control devices 10, as well as one, in particular a plurality of components 11. The components 11 are in particular each assigned to the brake system 7, the drive unit 8 or the steering device 9 as indicated by a dashed arrow.

The control device 10 is in particular configured to monitor the actuating devices 2, 3, 4, the sensors 5, 6 and/or the components 11 for a malfunction, and to control the brake system 7, the drive unit 8 and the steering device 9 as a function of actuation of the actuating device 2, 3, 4 as indicated by arrows.

An advantageous method for operating the motor vehicle 1 is described in the following with reference to FIG. 2. FIG. 2 shows the method using a flow chart. The method in particular ensures that safe continued operation of the motor vehicle 1 is advantageously ensured if it is no longer possible to clearly determine and implement an actuation of the actuating devices 2, 3, 4 due to a faulty actuating device 2, 3, 4 and/or a faulty Sensor 5, 6.

In a step S1, the method begins by monitoring the actuating devices 2, 3, 4 and the sensors 5, 6 for a malfunction. If a malfunction is detected, the method is continued with a step S2.

In step S2, at least one parameter assigned or assignable to the motor vehicle 1 is ascertained. The parameter in particular includes a severity and/or type of malfunction, an error state of at least one of the further components 11, a location information of the motor vehicle 1, an environment information of the motor vehicle 1, a surroundings information of the motor vehicle 1, a setting of a vehicle assistance system of the motor vehicle 1 and/or at least one destination for the motor vehicle 1.

In a step S3, an at least partially autonomous driving mode of the motor vehicle 1 is activated and at least one autonomous driving maneuver is carried out as a function of a value of the parameter ascertained in step S2. In particular at least two of the aforementioned parameters, in particular all of the parameters, or their values, are taken into account, and at least one or a plurality of appropriate driving maneuvers are accordingly specified as described above.

A suitable destination is selected from a plurality of destinations as a function of at least one of the parameters, for example, and a plurality of autonomous driving maneuvers are carried out to reach the selected destination. Preferably, control over the faulty, in particular over all of the actuating device 2, 3, 4, is taken away from the driver.

In a step S4, there is a check to see whether the malfunction has been resolved. If the malfunction is identified as not having been resolved, the method returns to step S3 and further autonomous driving maneuvers are carried out as needed. However, if it is recognized in step S4 that the malfunction has been resolved, the autonomous driving mode can be deactivated, for example in response to a request from the driver. The system now either waits until the driver requests deactivation of the autonomous driving mode or the autonomous driving mode is automatically deactivated.

The method then ends with a step S5, in which the autonomous driving mode is deactivated and control of the motor vehicle 1 is fully returned to the driver.

1-13. (canceled)

14. A method for operating a motor vehicle, the motor vehicle including at least one actuating device which can be actuated by a driver for specifying a braking and/or acceleration and/or steering request, wherein the actuating device is assigned at least one first sensor for detecting an actuation of the actuating device, the method comprising the following steps:
monitoring the actuating device and/or the first sensor for a malfunction; and
based on detecting a malfunction of the actuating device and/or the first sensor, activating an at least partially autonomous driving mode of the motor vehicle and carrying out at least one autonomous driving maneuver as a function of a value of at least one specified parameter assigned or assignable to the motor vehicle.

15. The method according to claim 14, wherein the actuating device is assigned at least one second sensor for redundantly detecting the actuation, and wherein sensor signals from the first and the second sensors are monitored for a malfunction, by comparing them with one another.

16. The method according to claim 14, wherein a steering device and/or a brake system and/or a drive unit of the motor vehicle is controlled as a function of an actuation of the actuating device.

17. The method according to claim 14, wherein: (i) a driving mode according to SAE level 3 (automated) or level 4 (highly automated) or level 5 (fully automated) is activated, and the driving mode can only be deactivated again or is deactivated, when the malfunction is identified as having been resolved, and/or (ii) control over the actuating device having the malfunction and/or another actuating device, is taken away from the driver.

18. The method according to claim 14, wherein the parameter includes a severity and/or a type of malfunction.

19. The method according to claim 14, wherein an error state of at least one further component of the motor vehicle is monitored, and the parameter includes the error state.

20. The method according to claim 14, wherein location information of the motor vehicle is acquired, and the parameter includes the location information.

21. The method according to claim 14, wherein environment information and/or surroundings information of the motor vehicle is acquired and the parameter includes the environment information and/or the surroundings information.

22. The method according to claim 14, wherein the parameter includes a setting of a vehicle assistance system of the motor vehicle.

23. The method according to claim 14, wherein at least one destination for the motor vehicle is specified or retrieved, and that the parameter includes the at least one of the destinations.

24. The method according to claim 18, wherein a suitable destination is selected from a plurality of destinations as a function of: (i) the severity and/or type of malfunction, and/or (ii) an error state, and/or (iii) location information, and/or (iv) environment information, and/or (v) surroundings information and/or (vi) a setting of the vehicle assistance system, and a plurality of autonomous driving maneuvers are carried out to reach the selected destination.

25. A control device for operating a motor vehicle, the motor vehicle including at least one actuating device which can be actuated by a driver for specifying a braking and/or acceleration and/or steering request, wherein the actuating device is assigned at least one first sensor for detecting an actuation of the actuating device, the control device configured to:
monitor the actuating device and/or the first sensor for a malfunction; and
based on detecting a malfunction of the actuating device and/or the first sensor, activate an at least partially autonomous driving mode of the motor vehicle and carry out at least one autonomous driving maneuver as a function of a value of at least one specified parameter assigned or assignable to the motor vehicle.

26. A motor vehicle, comprising:
at least one actuating device which can be actuated by a driver for specifying a braking and/or acceleration and/or steering request;
at least one first sensor, wherein the actuating device is assigned the at least one first sensor; and
a control device configured to operate a motor vehicle, the control device configured to:
monitor the actuating device and/or the first sensor for a malfunction;
based on detecting a malfunction of the actuating device and/or the first sensor, activate an at least partially autonomous driving mode of the motor vehicle and carry out at least one autonomous driving maneuver as a function of a value of at least one specified parameter assigned or assignable to the motor vehicle.
